(19) United States
(12) Patent Application Publication
(10) Pub. No.: US 2003/0015855 A1
(43) Pub. Date: Jan. 23, 2003

(54) Fifth wheel hitch assembly with improved jaw mechanism

(76) Inventors: Richard W. McCoy, Granger, IN (US); Thomas W. Lindenman, South Bend, IN (US)

Correspondence Address: KING & SCHICKLI, PLLC, 247 NORTH BROADWAY, LEXINGTON, KY, 40507, US

(21) Appl. No.: 10/189,641

(22) Filed: Jul. 3, 2002

Related U.S. Application Data
(60) Provisional application No. 60/303,175, filed on Jul. 5, 2001.

(51) Int. Cl. B62D 53/06

(52) U.S. Cl. 280/433

(57) ABSTRACT

A fifth wheel hitch assembly for towing a trailer includes a base, a skid plate and a locking jaw assembly. The locking jaw assembly includes a first jaw having a first gear set, a cooperating second jaw having a second gear set and a control handle for displacing the jaws between open and closed positions. Both the skid plate and the base are weldless, seamless and of unitary one-piece construction.

This application claims the benefit of U.S. Provisional Patent Application Serial No. 60/303,175 filed on Jul. 5, 2001.

### TECHNICAL FIELD

The present invention relates generally to the trailer towing field, and more particularly, to a fifth wheel hitch incorporating an improved locking jaw assembly.

### BACKGROUND OF THE INVENTION

Fifth wheel hitches are well known to those in the trailer towing field. Various models of fifth wheel hitches have been manufactured and sold by Reese Products, Inc. The fifth wheel hitches generally include a base which is held in the bed and mounted to the frame of a pick up truck. The base supports a head assembly including a skid plate and a locking jaw mechanism for securing the king pin of the trailer being towed in proper position with the weight of the trailer properly supported on the skid plate. An example of a fifth wheel hitch incorporating such a structural arrangement is found in U.S. Pat. No. 4,721,323 to Czuk et al.

While the jaw assembly mechanism described in the Czuk et al. patent functions beautifully for its intended purpose, it should be appreciated that it is a relatively complicated structure incorporating coupling plates or links with a radially extending slot and cooperating pivot pin providing interconnection between the two jaws of the assembly. This arrangement incorporates a relatively large number of parts, which disadvantageously increase manufacturing costs. A need is therefore identified for a new, simpler jaw assembly that is less expensive to produce yet still provides reliable operation over a long service life.

### SUMMARY OF THE INVENTION

In accordance with the purposes of the present invention as described herein, a fifth wheel hitch assembly is provided for towing a trailer behind a towing vehicle. The fifth wheel hitch assembly includes (a) a base, (b) a skid plate received on the base and including an opening for receiving a king pin of the trailer and (c) a locking jaw assembly carried on the base for engaging the king pin of the trailer when the king pin is properly received in the opening in the skid plate. The locking jaw assembly is characterized by a first jaw including a first gear set, a second jaw including a second gear set and a control handle for displacing the first and second jaws between open and closed positions.

More particularly describing the invention, the first gear set and second gear set mesh so as to insure precise movement of the two jaws under substantially any foreseeable operating conditions. The first jaw also includes a lug for engaging the control handle. The control handle and lug are connected together by a first pivot pin.

In accordance with yet another aspect of the present invention, the fifth wheel hitch assembly includes an inner mounting platform that is provided between the skid plate and the base. The first jaw is pivotally mounted to the inner mounting platform on a first stub shaft. The second jaw is pivotally mounted to the inner mounting platform on a second stub shaft.

A first tensioning spring extends between the first jaw and the inner mounting platform. A second tensioning spring extends between the second jaw and the inner mounting platform. Together, the tensioning springs bias the jaws toward a closed position.

In accordance with yet another aspect of the present invention the skid plate of the fifth wheel hitch assembly is machined or forged so as to be weldless and seamless and of a unitary or one-piece construction. Similarly, the base is also machined or forged so as to be weldless and seamless and of unitary or one-piece construction.

Still other features and advantages of the present invention will become readily apparent to those skilled in this art from the following description wherein there is shown and described a preferred embodiment of this invention simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrates several aspects of the present invention, and together with the description serves to explain the principles of the invention. In the drawings:

FIG. 1 is an exploded perspective view of the fifth wheel hitch of the present invention;

FIG. 2 is a top plan view with the skid plate removed showing the locking jaw assembly in the open position for receiving the king pin of a trailer;

FIG. 3 is a detailed perspective view showing a king pin in the throat of the locking jaw assembly which is open for receipt of the king pin of the trailer; and

FIG. 4 is a detailed top plan view showing the locking jaw assembly in the closed position for securely holding the trailer king pin;

FIG. 5 is a detailed perspective view showing the trailer king pin assembly held in the jaw assembly; and

FIG. 6 is a detailed perspective view of the jaw of the jaw assembly including the lug for securing the jaw to the control handle.

Reference will now be made in detail to the present preferred embodiment of the invention, an example of which is illustrated in the accompanying drawings.

### DETAILED DESCRIPTION OF THE INVENTION

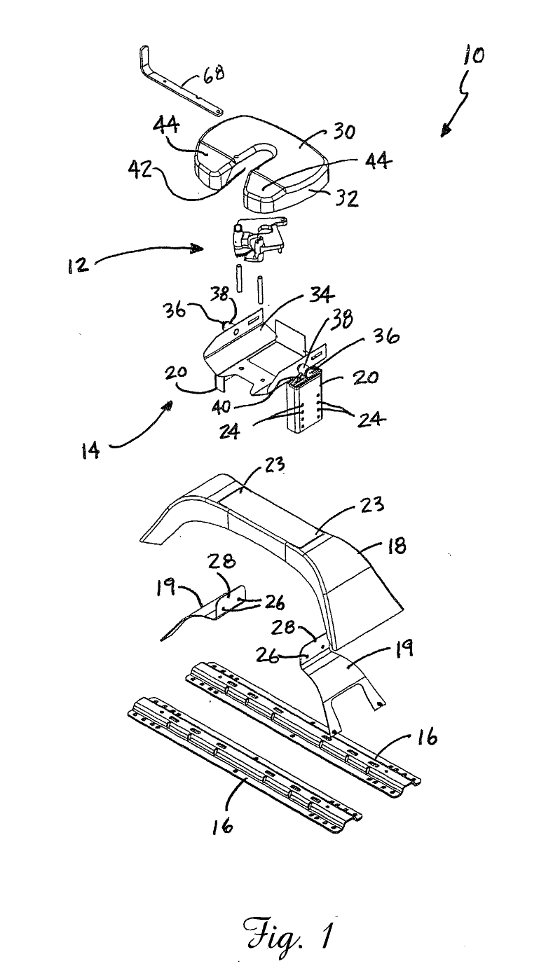

Reference is now made to the drawing figures showing the fifth wheel trailer hitch assembly 10 of the present invention incorporating the new and improved locking jaw assembly 12. As made clear from the drawing figures and the description that follows, the jaw assembly 12 may be incorporated into the head assembly 14 of the fifth wheel hitch 10 of the type shown in FIG. 1. It should be appreciated, however, that the description of the fifth wheel hitch 10 should only be considered as being illustrative and that the jaw assembly 12 is not limited to application in this specific fifth wheel hitch assembly design.

The fifth wheel hitch 10 includes a support frame comprising a pair of spaced, parallel rails 16 that are bolted to the frame of the towing vehicle (not shown) and a unitary or one piece base 18. The base 18 is machined or forged from 10 gauge steel so as to be both weldless and seamless and thereby provide a smooth, continuous and aesthetically pleasing structure. The base 18 is further rigidified by a pair of gussets 19 that are welded to the underside of the base, one at each side. The base 18 with the gussets 19 welded thereto is releasably secured to the rails 16 so as to straddle the rear axle of the towing vehicle. In this position the base 18 serves to support the head assembly 14 of the trailer hitch 10.

The base 18 carries two spaced, upright posts 20 (only one visible in FIG. 1) that are secured to the base by means of a fastener (not shown). More specifically, the proximal end of each post is received in a cooperating U-shaped slot 23 in the upper wall of the base 18. Apertures 24 in the posts 20 are then aligned with apertures 26 in an upstanding lug 28 on each gusset 19. The fasteners (e.g. cooperating bolts and nuts not shown) are then inserted into the aligned apertures 24, 26 to complete the connection.

The head assembly 11 includes a unitary or single-piece skid plate 30 machined or forged from 10 gauge steel. The skid plate 30 is weldless and seamless and provides an aesthetically pleasing, smooth, continuous surface. As shown, the skid plate 30 includes a downwardly depending skirt 32. An inner mounting platform 34 is welded or otherwise secured to the underside of the skid plate 30 where it is hidden from view by the skirt 32. The inner mounting platform 34 carries a pair of opposed cooperating pivot pins 36. The pivot pins 36 project laterally from the inner mounting platform 34 in opposite directions. One of the pivot pins 36 engages in a pivot pin receiving tube 38 welded with reinforcing gussets 40 to the top of one of the posts 20 while the other pivot pin engages in a like structural arrangement on the other post. This allows the head assembly 11 to pivot relative to the base 18 to which it is secured. Thus, the head assembly 11 and therefore the skid plate 30 are capable of tilting in the fore-and-aft direction during connection to and towing of a trailer.

As should be further appreciated from viewing drawing FIG. 1, the skid plate 30 includes an opening 42 for receiving a king pin K of a trailer to be towed by the fifth wheel assembly 10. The skid plate 30 also includes an upwardly sloped surface 44 on each side of the opening 42 to engage the mating skid plate on the trailer and aid in directing the king pin K into proper position during the process of connecting the trailer to the trailer hitch assembly 10.

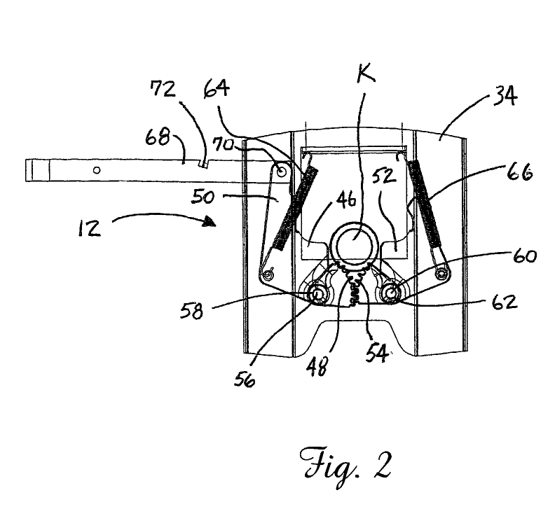

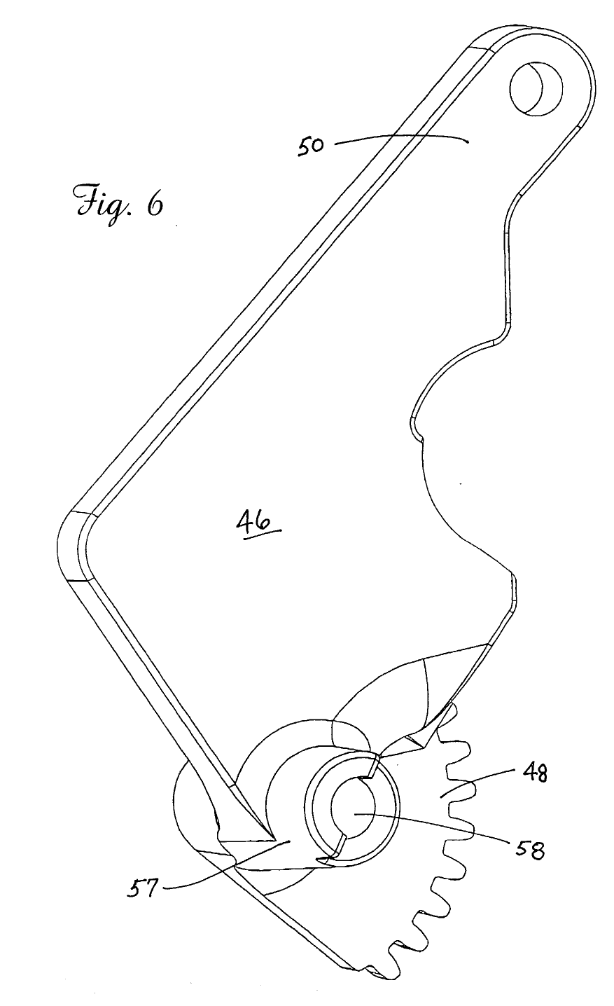

As best shown with reference to FIGS. 2-5, the locking jaw assembly 12 is mounted to the head assembly 11 between the skid plate 30 and the inner mounting platform 34. The locking jaw assembly 12 comprises a first jaw 46 including a first gear set 48 and a projecting lug 50 (see also FIG. 6). The locking jaw assembly 12 also includes a second jaw 52 including a second gear set 54. The two jaws 46, 52 may be cast or machined from steel with each jaw being of unitary construction. A first pivot pin 56 is welded to the inner mounting platform 34. The first jaw 46 is mounted to the pivot pin 56 by means of a boss 57 including a pivot pin receiving aperture 58. The first jaw 46 freely pivots on the pivot pin 56. A second pivot pin 60 is welded to the inner mounting platform 34 at a second position. The second pin 60 passes through an aperture 62 in a boss 63 of the second jaw 52. The second jaw 52 freely pivots on the pivot pin 60. When mounted in proper position on the pivot pins 56, 60, the first and second jaws 46, 52 are positioned with the first gear set 48 fully meshing with the second gear set 54 underlying the opening 42 in the skid plate 30.

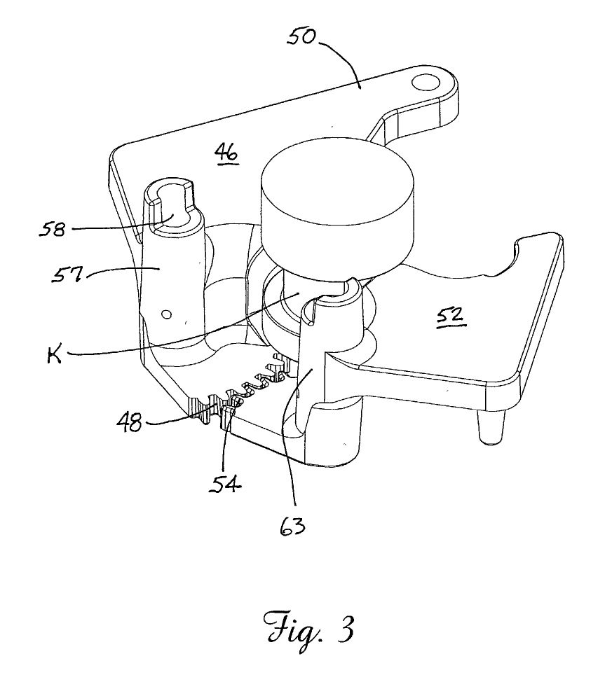

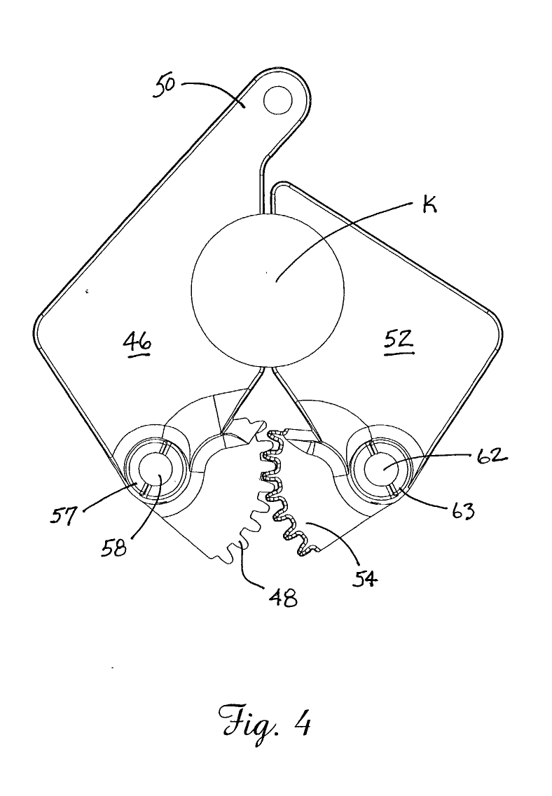

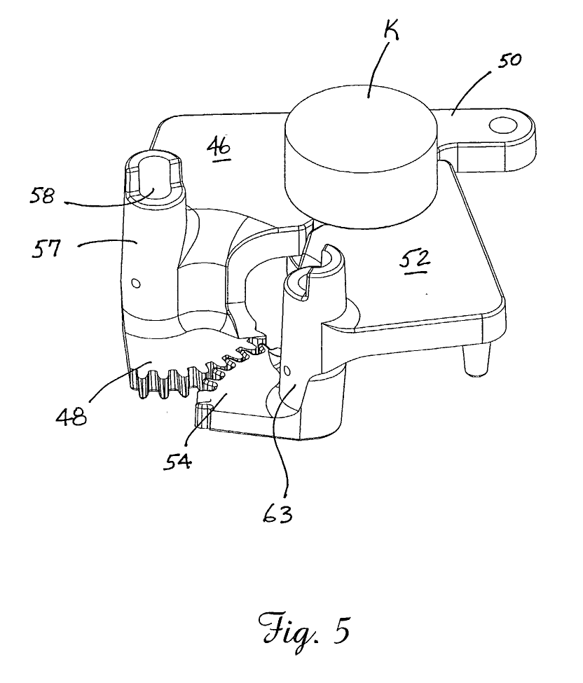

A first tensioning spring 64 is connected at one end to the inner mounting platform 34 and at the other end to the first jaw 46. A second tensioning spring 66 is connected at one end to the inner mounting platform 34 and at the other end to the second jaw 52. Together, the tensioning springs 64, 66 serve to bias the first and second jaws 46, 52 to the fully closed position shown in FIGS. 4 and 5. A control handle 68 extends through an aperture in the skirt 32 of the skid plate 30 and is connected by means of the pivot pin 70 to the projecting lug 50 of the first jaw 46. As shown, the control handle 68 may be formed from a flat steel bar, which includes a notch 72. The control handle 68 may be pulled outwardly from the skid plate 30 and shifted laterally to engage the notch 72 with the skirt 32 of the skid plate 30 in order to hold the first and second jaws 46, 52 of the locking jaw assembly 12 in the open position shown in FIGS. 2 and 3.

With the locking jaw assembly 12 in the open position shown in FIGS. 2 and 3, a trailer may be connected to the trailer hitch assembly 10. Specifically, the vehicle carrying the trailer hitch assembly 10 is slowly backed underneath the trailer with the king pin K of the trailer aligned with the opening 42 in the skid plate 30. As the vehicle backs under the trailer, the skid plate on the trailer engages the sloped surface 44 of the skid plate 30 of the trailer hitch assembly 10. This causes the trailer to rise slightly from the ground as the king pin K is directed through the throat of the opening 42 into its proper towing position. With the king pin K properly received in the opening 42 in the skid plate 30, the control handle 68 is manipulated to release the notch 72 from the skirt 32 of the skid plate 30. The tensioning springs 64, 66 then cause the first and second jaws 46, 52 to fully close and capture the king pin K in the proper position for towing the trailer (see FIGS. 4 and 5). The control handle 68 may then be locked in position with a latch (not shown) to insure that the locking jaw assembly 12 remains closed, capturing the king pin K during the towing operation.

Once towing is completed, the latch may be released and the control handle 68 may be manipulated/re-extended from the skid plate 30 so as to again open the jaws 46, 52 and place them in the position shown in FIGS. 2 and 3. The vehicle may then be pulled out from underneath the trailer to complete trailer disconnection.

In summary, numerous benefits result from employing the concepts of the present invention. The fifth wheel hitch assembly 10 incorporates a novel locking jaw assembly 12 incorporating a meshing gear arrangement 48, 54 which provides precise, cooperating movement of both jaws for reliable performance over a long service life. The locking jaw assembly 12 also incorporates fewer component parts so as to be less expensive to produce.

The foregoing description of the preferred embodiment of the invention has been presented for purposes of illustration and description. It is not intended to be exhaustive or to limit the invention to the precise form disclosed. Obvious modifications or variations are possible in light the above teachings. The embodiment was chosen and described to provide the best illustration of the principals of the invention and its practical application to thereby enable one of ordinary skill in the art to utilize the invention in various embodiments and with various modifications as are suited the particular use contemplated. All such modifications and variations are within the scope of the invention as determined by the appended claims when interpreted in accordance with the breath, to which they are fairly, legally and equitably entitled.

What is claimed

1.) A fifth wheel hitch assembly for towing a trailer behind a towing vehicle, comprising:
a base;
a skid plate received on said base and including an opening for receiving a king pin of the trailer; and
a locking jaw assembly carried on said base for engaging the king pin of the trailer when the king pin is properly received in said opening in said skid plate, said locking jaw assembly being characterized by a first jaw including a first gear set and a second jaw including a second gear set.

2.) The assembly of claim 1, further including a control handle for displacing said first and second jaws between open and closed positions.

3.) The assembly of claim 2, wherein said first gear set and said second gear set mesh.

4.) The assembly of claim 3, wherein said first jaw includes a lug for engaging said control handle.

5.) The assembly of claim 4, wherein said lug and said control handle are connected together by a first pivot pin.

6.) The assembly of claim 5, further including an inner mounting platform between said skid plate and said base.

7.) The assembly of claim 6, wherein said first jaw is pivotally mounted to said inner mounting platform on a first stub shaft and said second jaw is pivotally mounted to said inner mounting platform on a second stub shaft.

8.) The assembly of claim 7, further including a first tensioning spring extending between said first jaw and said inner mounting platform and a second tensioning spring extending between said second jaw and said inner mounting platform.

9.) A fifth wheel hitch assembly for towing a trailer behind a towing vehicle, comprising:
a base;
a weldless and seamless, one-piece skid plate received on said base and including an opening for receiving a king pin of a trailer; and
a locking jaw assembly carried on said base for engaging the king pin of the trailer when the king pin is properly received in said opening in said skid plate.

10.) A fifth wheel hitch assembly for towing a trailer behind a towing vehicle, comprising:
a weldless and seamless, one-piece base;
a skid plate received on said base and including an opening for receiving a king pin of a trailer; and
a locking jaw assembly carried on said base for engaging the king pin of the trailer when the king pin is properly received in said opening in said skid plate.
